(19) United States
(12) Patent Application Publication
(10) Pub. No.: US 2008/0162383 A1
(43) Pub. Date: Jul. 3, 2008

(54) METHODS, SYSTEMS, AND APPARATUS FOR LOWERING THE INCIDENCE OF IDENTITY THEFT IN CONSUMER CREDIT TRANSACTIONS

(76) Inventor: Harold H. KRAFT, Arlington, VA (US)

Correspondence Address: MILES & STOCKBRIDGE PC, 1751 PINNACLE DRIVE, SUITE 500, MCLEAN, VA, 22102-3833, US

(21) Appl. No.: 11/968,571

(22) Filed: Jan. 2, 2008

Related U.S. Application Data
(60) Provisional application No. 60/883,091, filed on Jan. 2, 2007.

(51) Int. Cl. G06Q 90/00

(52) U.S. Cl. 705/500

(57) ABSTRACT

A process, system, and apparatus are may lower the incidence of identity theft in consumer credit transactions through the use of an identity score. In a representative context, the entities involved include a prospective debtor, a prospective creditor, and a credit bureau. The credit bureau provides background information to the prospective creditor regarding the prospective debtor's credit risk. A process provides certain additional information to enhance this value and make it more resistant to misuse by fraudulent parties who stand in the shoes of prospective debtors. The process will also be used in conjunction with other current methods that prospective creditors employ in making such determinations, such as credit scores.

### CROSS REFERENCE TO RELATED APPLICATIONS

The present application claims priority to U.S. Provisional Application 60/883091 which was filed Jan. 2, 2007, hereby incorporated by reference in its entirety.

### FIELD

The present invention relates to identity theft in various types of transactions and more particularly to mechanisms that help to verify the authenticity of transaction requests.

### BACKGROUND

Identity verification is at the heart of many types of commercial and legal transactions. As transactions become automated and more frequently are done between parties who do not know each other personally. With the speed and number of transactions increasing, unconventional and reliable mechanisms for identity verification are continually being proposed and introduced. In modern transactions, identity verification has a number of aspects and definitions. In the context of transactions involving trust, the authentication issue which is of greatest concern is that a party involved in a transaction is actually who he represents himself to be.

The root cause of identity theft is the ability of a first party to pretend to be a third party by using information about the third party in a transaction with a second party. The second party may assume the poser is genuine if the poser knows certain information about the first party. One of the most robust ways of authenticating a person is to challenge the poser with questions about the third party. The questions may be selected at random and required to be answered in a predefined time interval. Passwords or symmetric or asymmetric keys can be used to authenticate a person, but these can be stolen, guessed, or otherwise acquired just as any other information about the third party.

Some computer security systems authenticate users by means of multi-factor authentication. An example is the use of a hardware key in combination with a username and password, often used in high-security computer networks. The hardware key may be, for example, a token carrier that sends a message directly into a user interface or displays a constantly-changing identification number that can be entered by the user. A poser would be required to obtain two factors: the username and password as well as the key in order to breach the security system.

US Patent Publication No. 2006/0204051 for “Method and system for managing account information” describes a system in which a user locks an account and requires that a PIN code be entered into his cell phone if the account is to be unlocked. In this way, a trusted service provide automatically calls the user's phone whenever a request is made to unlock the account. If the PIN is not entered, access to the account is denied. It is a kind of multi-factor verification system.

A number of systems have been proposed which rely on a trusted intermediary to verify a party to a transaction. U.S. Pat. No. 5,902,721 for “Method and system for secure online transaction processing” describes such a system. The system identifies a purchaser computer and a transaction type to a trust server which then authorizes the transaction or not.

Many states provide a legal right for consumers to put a “security freeze” on their credit files with any of the credit bureaus. A security freeze means the consumer file cannot be shared with potential prospective creditors. This can help prevent identity theft because most businesses will not open credit accounts without checking a consumer's credit history beforehand. If a consumer's credit files are frozen, even someone who has the consumer's name and even Social Security number is unlikely to find it possible to obtain credit in the consumer's name.

A security freeze is often free if consumers who can provide proof they are victims of identify theft. However, a fee can be paid to place a freeze, which is a nominal processing fee, generally. The fee may also be guaranteed by statute. Credit freezes give control to consumers permitting them to control the credit bureau regarding how they are permitted to distribute (usually a sale) the consumer's credit information. A frozen account locks the information until the subject gives permission for its release. Presently, the ability for consumers to invoke credit freezes is provided for by statute in some states.

Credit Freezes are an effective way to prevent identity theft. Each 15% of all cases of identity theft involve the creation of new accounts. This form of identity theft occurs when someone opens credit in another's name using fraudulent identifying information. A credit report is generally essential for a prospective creditor to assess the risk of a transaction involving the target individual. Since the credit freeze blocks access to the information, it effectively prevents the fraudulently used identifying information from having any value. Individuals whose accounts are frozen must unfreeze them before when they apply for credit themselves.

To place a freeze, currently, consumers must write to each of the three credit bureaus to identify themselves, provide a copy of a police report or other proof if appropriate, or provide a payment. While this is a useful device, it is generally used in special circumstances.

By unlawfully obtaining a consumer's personal identification information, identity thieves are able to breach routine security methods employed to safeguard financial transactions, victimizing both the consumer and prospective creditor. The relative ease by which identity thieves can come by the information required to perpetrate such a fraud has created a level of distrust among consumers being asked for sensitive personal data and among prospective creditors asked to extend credit to unknown persons.

Such distrust has strained financial transactions and thereby adversely impacts economic activity in all sectors of the economy. Current methods aimed at reducing the incidence of identity theft generally focuses on authentication through a password or PIN, sometimes coupled with an independent second identifier, such as hardware recognition. An effective, reliable and simple method of identity verification that is widely employed and accepted will significantly ease the flow of commerce and reduce costs throughout the financial system imposed by undetected fraud.

Another aid to facilitation of shoulder-length transactions involves verifying a party's claims about himself. Background checks, for example, provide a method of acquiring information on an individual through data sources provided, for example, by government organizations and private individuals. The information may be used to confirm assertions made by the subject or as an aid in predicting their future actions based on the subject's history. A type of background check, a so-called credit check, is provided in the form of a report by credit monitoring agencies. The reports are routinely used by creditors to assess credit worthiness of prospective parties. The validity of the information provided by reporting agencies is usually assumed. However, the information is often incorrect and the devices for correcting the information are usually crude concessions provided to the subjects of the credit profile information, such as the ability to make notations in the credit file.

There is an on-going need to provide for the authentication and authorization of parties to transactions. There is also a need to verify the correctness of information about authenticate persons.

### BRIEF SUMMARY

The process is a means of lowering the incidence of identity theft in consumer credit transactions through the use of multiple streams of verification data to arrive at an identity score. The process employs a process for reliable verification of identity data, along with objective data related the prospective debtor, the prospective creditor and the subject transaction to arrive at a subjective assessment of the likelihood that the credit applicant is not an imposter, to be called an “identity score”. The identity score is arrived at though a series of mathematical calculations, with the inputs being the data points collected under the process employed by the process.

### BRIEF DESCRIPTION OF THE DRAWINGS

The accompanying drawings, which are incorporated herein and constitute part of this specification, illustrate exemplary embodiments of the invention, and, together with the general description given above and the detailed description given below, serve to explain the features of the invention.

FIG. 1 shows the current standard process for initiating and completing a consumer credit request transaction.

FIG. 2 shows an improved process for secure credit transactions involving an identify verifier.

FIG. 3 shows the process for calculating the identity score identifies in FIG. 2, Step 7.

FIG. 4 shows the process for calculation the first of four input factors to the identity score, the interface with prospective debtor input factor referenced in FIG. 3, Step 1.

FIG. 5 shows the process for calculation the second of the four input factors to the identity score, the transaction profile input factor referenced in FIG. 3, Step 2.

FIG. 6 shows the process for calculation the third of the four input factors to the identity score, the prospective creditor's profile input factor referenced in FIG. 3, Step 3.

FIG. 7 shows the process for calculation the fourth of the four input factors to the identity score, the prospective debtor's profile/Rules input factor referenced in FIG. 3, Step 4.

### DETAILED DESCRIPTION OF THE EMBODIMENTS

According to one embodiment, process, system, and apparatus are provided which may lower the incidence of identity theft in consumer credit transactions through the use of an identity score. In a representative context, the entities involved include a prospective debtor, a prospective creditor, and a credit bureau. In this well-known context, a prospective debtor seeks to obtain something of value, such as a loan, based on his promise to pay for the thing, at some time in the future. The credit bureau provides background information to the prospective creditor regarding the prospective debtor's credit risk. According to an embodiment, a process is provided to which is contemplated for use in this context. That is, the process provides certain additional information to enhance this value and make it more resistant to misuse by fraudulent parties who stand in the shoes of prospective debtors. The process will also be used in conjunction with other current methods that prospective creditors employ in making such determinations, such as credit scores.

The following definitions are established to help make the presentation of the embodiments clearer and more convenient. However, please note that the definitions may vary based on the context of each embodiment.

A “prospective debtor” 210 is a person or entity, in an individual capacity or as a representative of an organization, who desires to enter into a financial transaction that will require the extension of credit, or trust, either by another party, usually a prospective creditor. The prospective debtor may also be one who seeks the use of a prospective debtor's funds in a form other than cash. A prospective debtor most typically, but not exclusively, will be a purchaser of goods or services such as commodity items, revolving credit, loans, mortgages, real estate, etc. The category may also include one of the parties to a contract in which mutual exchanges of promises are made. In the latter case, an entity may be a prospective debtor and a prospective creditor at the same time.

A “prospective creditor” 220 is a seller or third party who desires to enter into a financial transaction with a prospective debtor that will require the extension of credit to the prospective debtor or another party on the prospective debtor's behalf, or the use of prospective debtor's own funds in a form other than cash. A prospective creditor most typically, but not exclusively, will be a seller of goods or services such as commodity items, revolving credit, loans, mortgages, real estate, etc. The category may also include one of the parties to a contract in which mutual exchanges of promises are made. In the latter case, an entity may be a prospective debtor and a prospective creditor at the same time.

A “credit bureau” 230 is a service provider employed by a prospective creditor to assist in the evaluation of the credit worthiness of a prospective debtor. In the inventive embodiments, the standard concept of a credit bureau may be expanded to include any kind of trusted information provider or information aggregator or service. As may be seen below, the traditional services of a credit bureau may be expanded to encompass those of an identify verifier and/or background information provider.

An “identity verification service” is a service or services that provides information content to a party to a transaction (for example, prospective creditor) thereby providing additional information to a prospective creditor or other party in making a determination as to whether to enter into, or continue, a transaction, for example, whether to issue credit to a prospective debtor, and on what terms. An identify verifier would provide a previously non-existent service to the prospective creditor to assist its evaluation of whether to issue credit to a prospective debtor, and on what terms by providing the prospective creditor with an identity score and an identity report.

An “identity verifier” 240 is a party that provides an identity information service to a party to a transaction (for example, prospective creditor).

An “identity report” is background information which a party to a transaction can use in assessing the trustworthiness of a second party to a prospective transaction. For example, the identity report could include a background check report such as described in U.S. patent application Ser. No. 11/562571 filed Sep. 22, 2006 for “PRIVACY MANAGEMENT AND TRANSACTION SYSTEM,” which is hereby incorporated by reference in its entirety herein. It may also include an identity score or other synthesized information or lump parameters derived from the background information and collected by the identity verifier 310.

An “identity score” 370 is symbol provided to a prospective creditor that represents the probability that a representation as to the identity of a party to a transaction are made by the party identified.

“Identity score input factors” 360 include information which is further refined or combined with other information to derive an identity score. The factors may include, for example: (1) the interface with prospective debtor input factor 320, (2) the transaction profile input factor 330, (3) the prospective creditor's profile input factor 340, and (4) the prospective debtor's profile/rules input factor 350.

A “communication device” 420 is any type of communication device that may be employed by the identity verifier to communicate, directly or indirectly, with the prospective debtor. Examples include email, handheld or otherwise, land-line telephone (POT), postal mail, web site, telephone message, pager, fax, wireless or fixed personal digital assistant (PDA, e.g., WAP (wireless application protocol)-enabled mobile phone or PDA), SMS or other text, voice, or other kind of messaging device, or any other type of communication device.

“Interface with prospective debtor input factor” 320 is a primary identity score input factor 360 which is derived from the prospective debtor interface inputs 440.

A “raw score for interface with prospective debtor input factor” 450 is a symbol that is assigned to the interface with prospective debtor input factor 320 for use in calculating the identity score 370.

“Prospective debtor interface inputs” 440 are factors used to determine the raw score for interface with prospective debtor input factor 450.

“Transaction profile input factor” 330 is a primary identity score input factor 360 arrived at derived in response to the transaction profile inputs 560.

A “raw score for transaction profile input factor” 570 is a mathematical figure assigned to the transaction profile input factor 330 for use in calculating the identity score 370.

“Transaction profile inputs” 560 are factors used to determine the raw score for interface with prospective debtor input factor 570.

“Prospective creditor's profile input factor” 340 is a primary identity score input factor 360 arrived at derived in response to the prospective creditor's profile inputs 670.

A “raw score for prospective creditor's profile input factor” 680 is a mathematical figure assigned to the prospective creditor's profile input factor 340 for use in calculating the identity score 370.

“Prospective creditor's profile inputs” 670 are factors used to determine the raw score for prospective creditor's profile input factor 680.

“Prospective debtor's profile/Rules input factor” 350 is a primary identity score input factor 360 arrived at derived in response to the prospective debtor's profile/Rules input 770.

A “raw score for prospective debtor's profile/Rules input factor” 780 is a mathematical figure assigned to the prospective debtor's profile/Rules input factor 350 for use in calculating the identity score 370.

“Prospective debtor's profile/Rules inputs” 770 are factors used to determine the raw score for prospective debtor's profile/Rules input factor 780.

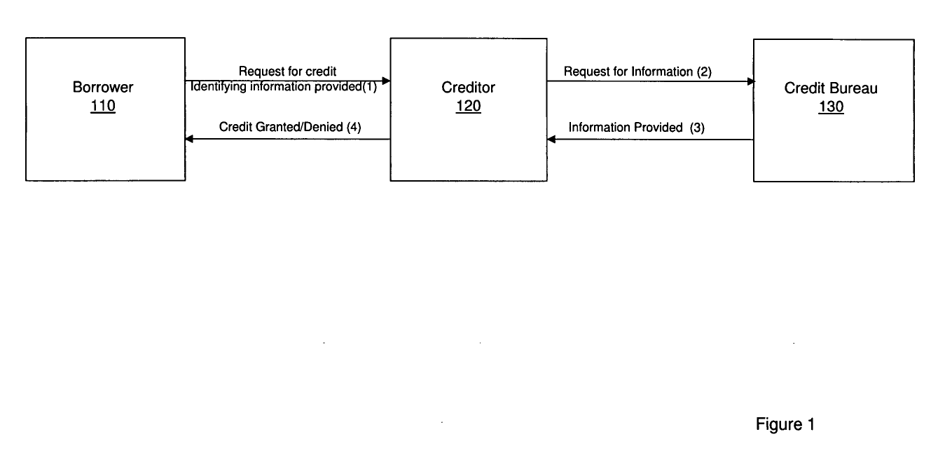

Referring to the drawings, FIG. 1 shows a known process for initiating and completing a consumer credit request transaction with credit history and scores provided by a prospective creditor 120. A prospective debtor 110 makes a request of a prospective creditor 120 for some amount of credit, a revolving credit instrument such as a charge card, a loan, or some other credit vehicle or benefit. To facilitate the transaction, the prospective creditor seeks to determine the identity of the prospective debtor 110 and credit risk information associated with that identity that may help to indicate the risk of the contemplated transaction (e.g., extension of the loan).

To obtain the credit risk information, the prospective creditor 120 obtains information that is sufficient to identify the prospective debtor 110 uniquely. This identifying information may include, for example, the name, address, and social security number of the prospective debtor 110. The identifying information is then transmitted to a credit bureau 130 which uses it to look up a record, or records, in its databases and compile a credit report. The record or records are usually called the target entities credit file. The databases may include information from past credit transactions by the prospective debtor which provides a report disclosing information about the credit-worthiness of the prospective debtor 110 based on the identifying information transmitted to it.

Generally, the prospective creditor 120 makes the assumption that if the prospective debtor 110 can produce the identifying information, the detailed nature of that information is sufficient to authenticate the entity (in this case, prospective debtor 110) providing it. In other words, the prospective creditor 120 assumes the prospective debtor 110 is who he says he is. The information supplied by the credit bureau 130 may or may not be useful at all for verifying that the identity information on which it is based corresponds to the agent or person which supplied it (in this case, prospective debtor 110) to facilitate the acquisition of credit in the identified entity's name. Ultimately the decision whether to grant credit or not is based on the credentials of the entity identified by the prospective debtor 110, which or may not be the same as this person or entity (in this case, prospective debtor 110). Generally, the information supplied by the credit bureau 130 simply provides useful input for the prospective creditor 120 to assess risk and thereby allow him to define permissible terms for the contemplated transaction.

The above context is a paradigmatic one for the problem of identity theft. An identity thief with identifying information corresponding to an absent third party (the victim, in this case) can represent himself as the prospective debtor 110 and obtain rights in a transaction by deceiving the prospective debtor 120. The thief does this by providing the absent third party's identifying information instead of his own.

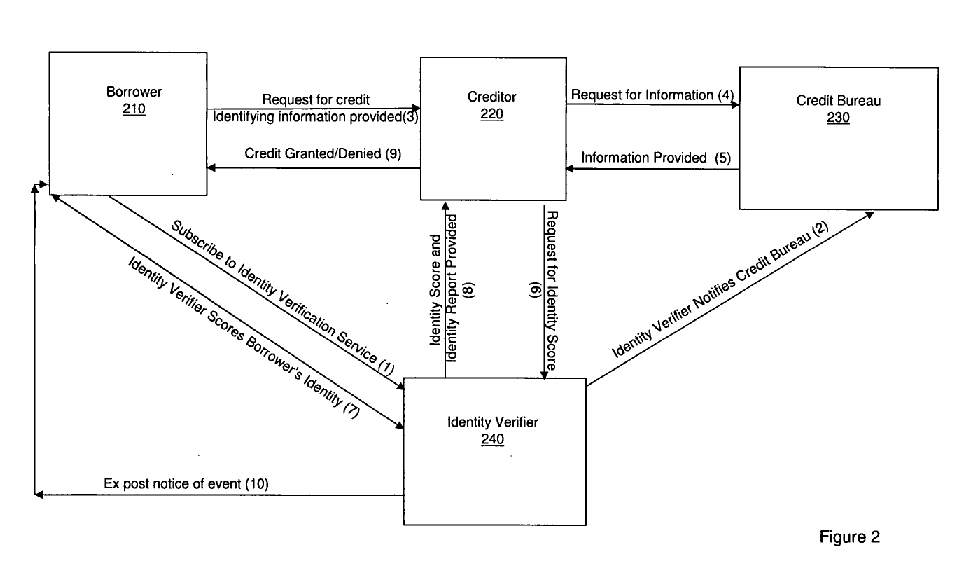

FIG. 2 is a diagram showing a step-by step process in which a prospective debtor 210 uses an identity verification service provided by an identity verifier 240 to obtain information that augments the information provided in the scenario of FIG. 1. In the present embodiment, the prospective debtor 210 is a subscriber to the service provided by the identity verifier 240. So the first step is for the prospective debtor 210 to subscribe to the identity verification service by contracting with the identity verifier 240.

The identity verifier 240 notifies the credit bureau(s) 230, with prospective debtor's 210 consent (which may be part of the contract), that prospective debtor 210 has subscribed to its identity verification service and requests that a notation be made in prospective debtor's 210 credit report to that effect. The latter may be in the form of a fraud alert or other notification on the prospective debtor's 210 credit file (the record or records corresponding to the prospective debtor's 210 unique identity). It may also take the form of a credit freeze, which prevents the reporting of the credit bureau information to any requester without the requester (prospective creditor 220) or credit bureau 203 taking some further action, for example, obtaining the permission of the target (identified prospective debtor 210).

When a prospective debtor 210 subsequently requests credit from a prospective creditor 220 and the prospective creditor 220 requests a credit report from a credit bureau 230, the prospective debtor's 210 credit report will include either a notation directing the prospective creditor 220 to contact the identity verifier 240 for an identity score 370 or the credit report will be withheld until the permission of the identified prospective debtor 210 provides approval to the credit bureau 230 to transmit it to the requesting prospective creditor 220. Currently the notation is something that the credit bureaus 230 generally provide as a service to the target entities in their files. However, some states require that credit bureaus 230 also permit entities to freeze their reports, blocking their transmission without the approval of the target entity. Either or both types of impediments or some similar kind of impediment could be used to invoke the further involvement of the identity verifier 240 in the transaction as discussed below.

The prospective creditor 220 may, in response to the freeze or alert on the target's file, will be notified to contact the identify verifier 240. If the embodiment employs the alert, the notification will be included in the fraud alert message accompanying the report. In the case of the refusal to provide the report, in the credit-freeze embodiment, the credit bureau 230 may provide a message to the prospective creditor 220 to contact the identity verifier 240 to lift the freeze. In either case, the identify verifier 240 is involved in the transaction to provide permission to access the credit file or to provide additional information to confirm that the target and the prospective debtor are the same entity.

In addition to using a freeze or alert on the target's file, the prospective creditor 220 may also voluntarily determine if the identified prospective debtor 210 is a subscriber to the identity verification service offered by the identity verifier 240. The prospective creditor 220 may access a database offered by the identity verifier 240, such as by the Internet or by calling a customer representative. The prospective creditor 220 may then provide predetermined identifying information to ensure to the identity verifier 240 that the request for confirmation that the identified prospective debtor 210 is a subscriber. The identity verifier 240 may then confirm that the prospective debtor 210 is a subscriber and/or provide the additional information in the identity score and/or identity report described below. In a variation on this latter embodiment, the identity verification service may be offered as a subscription service to prospective creditors 220. In the latter case, obtaining the information preferably includes logging into the service by authenticating the prospective creditor 220.

Whether the identity information service is subscription or not, preferably the identity information service 220 utilization procedure includes the prospective creditor 220 identifying and authenticating himself to the service's interface to provide input so that the identity information service may be made less susceptible to abuse. An example of steps that may be followed, on the identity verifier's server-side in a client-server context, are:
Register new prospective creditor 220 as user of the identity verification service (including prompting for and receiving identification information of the prospective creditor entity).
Check prospective creditor 220 background. Determine likelihood of abuse based on information including previous misuse of services or correlated information.
Create login credentials and supply to user or deny registration depending on outcome of previous step.
Login in user (skip to this step if a previously registered user)
Check prospective creditor 220 previous use history to identify possible abuse. For example, a prospective creditor 220 with a high frequency of failures to verify the target prospective debtor's identity is preferably employed as an indication of improper use of the identity verification service. Another factor may be if the prospective creditor 220 repeatedly supplies the same identifying information related to the same type transaction in a short span of time.
Receive identifying information of a new prospective debtor 210 (or debtors—typically this would be available as a batch request for multiple inquiries) and information defining the type of transaction (that is, the product or service that is contemplated in the transaction).
Perform identity verification process or processes (describe below) including receiving feedback from the user.
Compile user feedback in a record for the registered prospective creditor to provide a record of previous uses and outcomes.

In response to the prospective debtor 210 identifying information, the identity verifier generates an identity report and, preferably, a distilled parameter such as a score which might be called an identity score 370. The latter may represent a best estimate of the probability that the identified prospective debtor 210 does not correspond to the entity posing as the identified prospective debtor 210. The calculation may include the methods and criteria described below. The identity report and identity score 370 may then be supplied to the prospective creditor 220 as illustrated in FIG. 2.

It may be left up to the prospective creditor 220 to use the supplied information including the identity report and score in such manner as it deems fit. As such, the identity report and identity score 370 may be compared with the prospective creditor's 220 private criteria in making its determination as to the risk of going ahead with the contemplated transaction. The identity report may supply raw data to allow the prospective creditor 220 to perform its own calculation of an identity score. The identity score and report supply information related to the likelihood of a fraudulent use of the identified prospective debtor 210. This is different from the credit score, normally supplied by credit bureaus 230, which merely indicates the credit-worthiness of the identified prospective debtor 210. If the identity score 370 either as-delivered by the identity verifier 240 or as determined by the prospective creditor 220 based on information in the identity report, is too low, it is contemplated that this would be used as a basis for refusing to enter the contemplated transaction with the entity which supplied the identifying information corresponding to the identified prospective debtor 210.

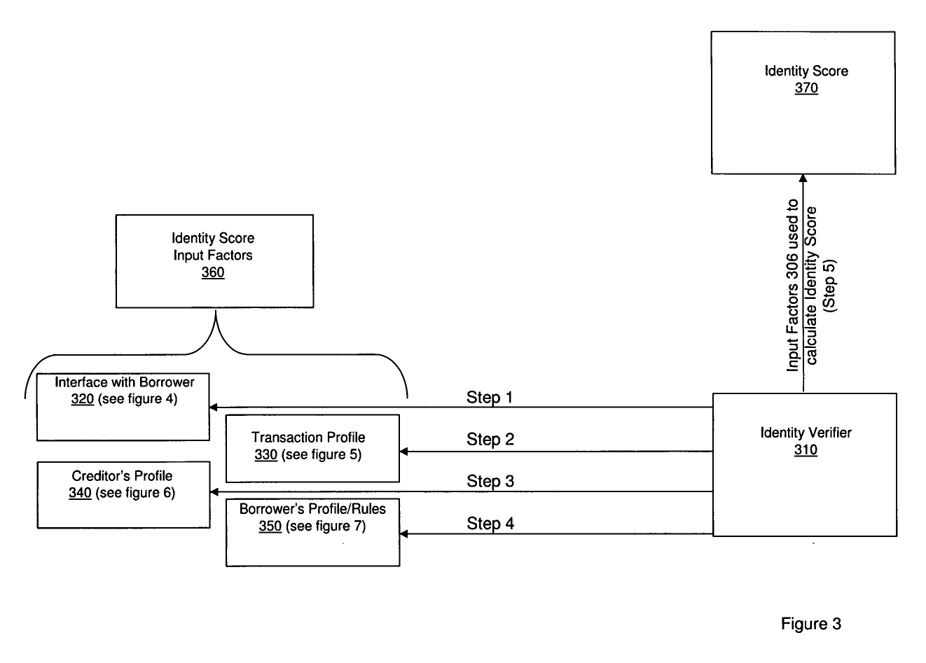

Referring now to FIG. 3, a diagram showing the process that an identity verifier 310 may use to collect information to be included in an identity report is shown in overview fashion. At least the four primary identity score input factors 360 are preferably provided for:

(1) the interface with prospective debtor input factor 320,

(2) the transaction profile input factor 330,

(3) the prospective creditor's profile input factor 340, and

(4) the prospective debtor's profile/Rules input factor 350.

The identity score input factors 360 are determined as described further below (See the figure numbers indicated in FIG. 3) and may be combined into a composite parameter or parameters such as the identity score 370.

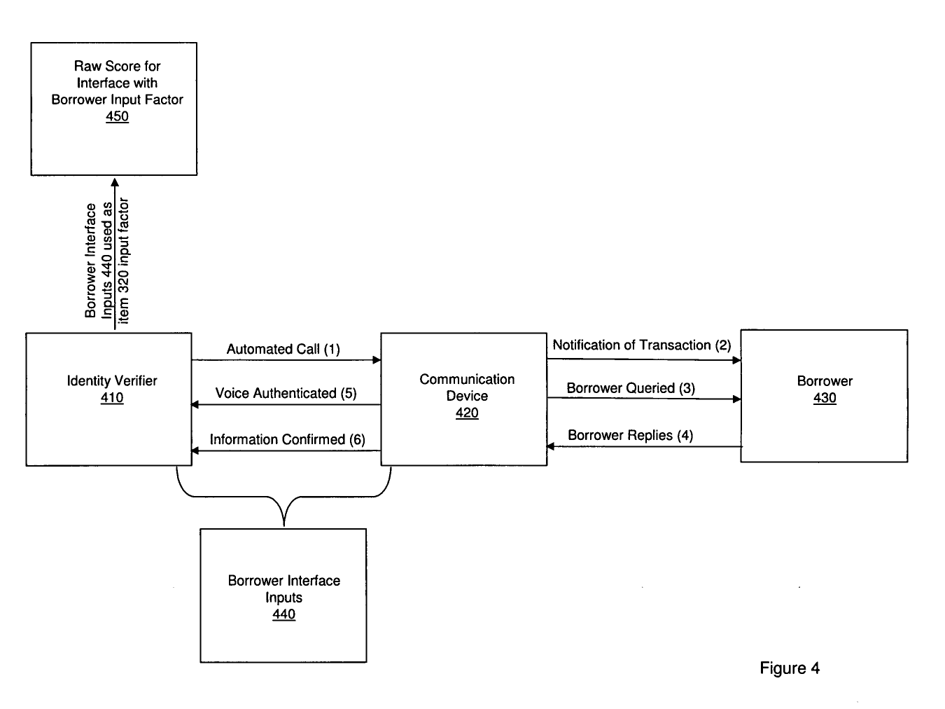

FIG. 4 illustrates the process by which the interface with prospective debtor 320 factor is obtained. Briefly, the identity verifier 410 attempts to communicate directly with the identified prospective debtor 430 using a predefined communications vehicle such as a cell phone or email. The substance of the communication is to confirm that the identified prospective debtor 430 acknowledges that the request for credit information by the prospective creditor 220 is authorized. The following is a representative procedure.

(1) The identity verifier 410 transmits a message to the prospective debtor through a predefined communications device. An example of how to set up an arrangement between the identity verifier and the prospective debtor and to establish a communications device for use for this purpose is described in U.S. patent application Ser. No. 11/373551 (publication 20060204051) for “Method and system for managing account information,” the entirety of which is hereby incorporated by reference. In this reference, a cell phone is used and it is uniquely associated with the identified prospective debtor 410 by the unique telephone number. In the present embodiment, the communications device 420 is preferably any kind of communications device including email, handheld or otherwise, land-line telephone (POT), postal mail, web site, telephone message, pager, fax, wireless or fixed personal digital assistant (PDA, e.g., WAP (wireless application protocol)-enabled mobile phone or PDA), SMS or other text, voice, or other kind of messaging device, or any other type of communication device. The message may contain a generic request for authorization to provide a credit report to a requester. Alternatively, the message may contain additional information such as information about the requester (prospective creditor 220), the nature of the transaction as indicated by the requester and/or other information.

(2) The identity verifier 410 receives (or fails to receive) a response from the prospective debtor communication device 420. The attempt to communicate may result in a failure to obtain a response. Steps 1 and 2 may be repeated multiple times with the outcome noted in each instance and recorded. The record may be added to a database maintained by the identity verifier. The record and other records may be provided by the identity verifier 410 in the identity report for use by the prospective creditor 220.

(3) The identity verifier 410 may prompt the user of the communication device 420 to authenticate himself, such as by speaking and using voice recognition to determine if the voice is that of the registered user. Alternatively, another type of biometric indicator may be communicated, for example, the communication device may have a fingerprint recognition sensor, iris scanner, retina scanner, built-in voice recognition engine, face scanner, etc., to authenticate the responding person. Other methods of authenticating the person responding may include a personal-information quiz in which the user is prompted to answer questions that only the user would be likely to know, such as prior residences, family members, etc. Secret questions may be asked, such as those that are often used for password recovery. Preferably, a combination of authentication methods are used, for example, the user may speak a secret phrase into the communications device and the voice pattern as well as the content may be compared with a standard to establish authenticity.

(4) Additional information may be obtained from the communication device 420 either by input from the supposed prospective debtor 410 or automatically. For example, the communication device 420, which may be a computer used to communicate through an instant messaging service, may communicate information such as an identifier of the processor. For another example, a cell phone may communicate the location of the cell phone as derived from a GPS signal. Comparison of the received information with predicted information may provide additional input regarding the reliability of the authentication attending the authorization to release the credit report (override the alert or freeze).

The identity verifier 410 may then calculate a raw score for the interface with prospective debtor input factor 450 based on the prospective debtor interface inputs 440 obtained by identity verifier's 410 communication with the prospective debtor 430 through the Communication Device 420. For example, the score may be lowered based on the number of attempts that had to be made before a return message was received. A lower score may attend the failure to make contact at all. A lower score may be derived from the quality of the authentication response, for example, the number of miscues of the voice response, the number of wrong answers to questions, low quality of match between the received voice response and the biometric standard, errors in the response, etc.

The feedback provided by the identity verifier 410 from communications or attempts at communications with the communication device 420 are packaged and communicated to the prospective debtor 220. This communication is represented as the interface with prospective debtor input factor 450. This information is combined with other identity score input factors 360 in the calculation of the identity score 370. The other input factors are discussed below.

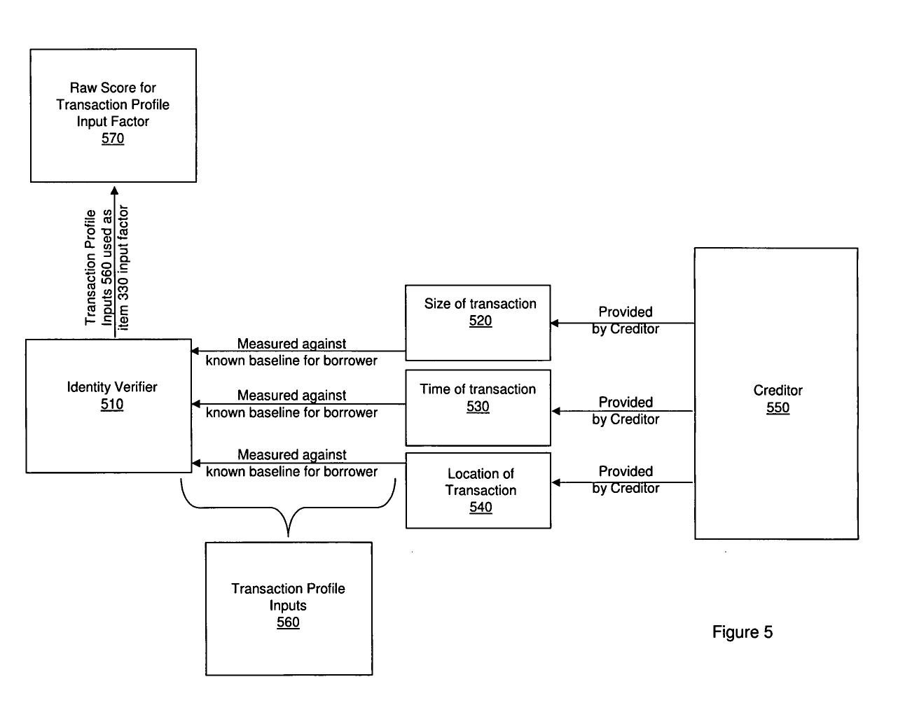

FIG. 5 illustrates examples of additional data that may be obtained and used by the identity verifier 510 or by the prospective creditor to derive an estimate of the likelihood that the entity providing the identified prospective debtor 410 is the same as the identified prospective debtor 410 or an authorized agent. The following are examples. In a preferred embodiment, these data are provided to the identity verifier 510 which safeguards the subscriber information and, based on the subscriber (identified prospective debtor in this case) can compare the proposed transaction with predicted transactions to provide further information about the likelihood of a non-fraudulent transaction. In these examples, pattern matching with prior transactions may provide relevant input to the identity score. As shown in FIG. 5, examples of the transaction profile inputs 560 include:

(1) The size of the transaction measured against a predicted baseline for the prospective debtor 210. The prediction may be obtained using prior patterns of the prospective debtor 410 or similar entities such as by the method of collaborative filtering.

(2) The time of the transaction measured against a predicted baseline for the prospective debtor 210. The prediction may be obtained using prior patterns of the prospective debtor 410 or similar entities such as by the method of collaborative filtering.

(3) The location of the transaction measured against a predicted baseline for the prospective debtor 210. The prediction may be obtained using prior patterns of the prospective debtor 410 or similar entities such as by the method of collaborative filtering.

For example, if the geographical location of the transaction is inconsistent with the identified prospective debtor's movements, or if the location belongs to class of locations that are suspect (for example, foreign or located in a country that is know to be tolerant of fraudulent business operations), then such information may be used to adjust the identity verification score. For another example, a prospective debtor 210 entering into a transaction near his or her office during normal business hours for a dollar amount and product or service class that is in line with prospective debtor's 210 typical purchasing habits would yield a high raw score for transaction profile input factor 570. In cases where one or more of the positive factors identified in the example are not present, the raw score for transaction profile input factor 570 would be correspondingly lower.

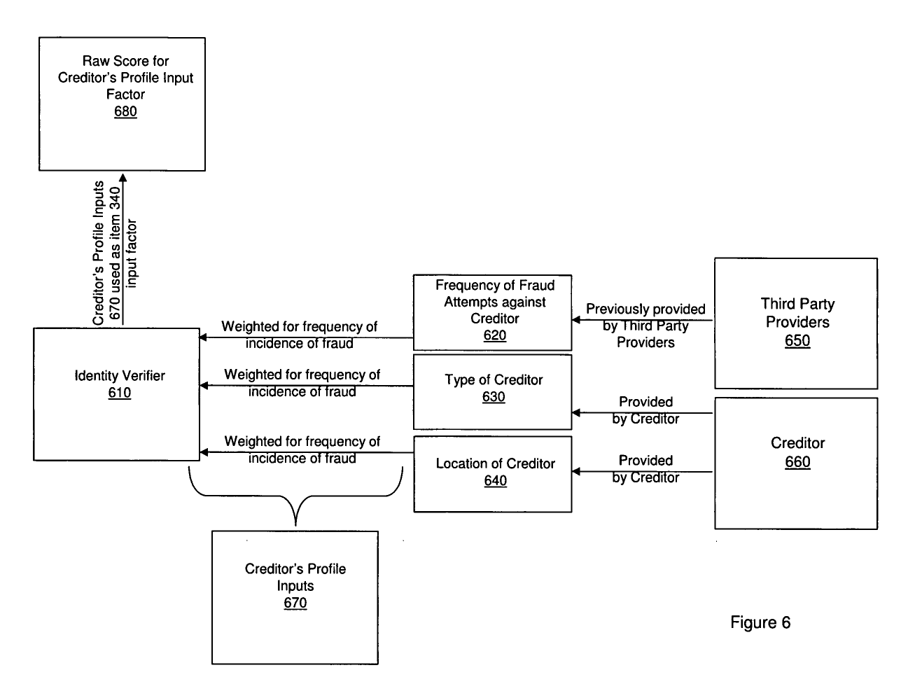

FIG. 6 illustrates a process for calculating a raw score for prospective creditor's profile input factor 680 based on the prospective creditor's profile inputs 670. The prospective creditor's profile inputs 670 may include, among other things, (1) the frequency of actual fraud attempts against the individual prospective creditor 660, (2) the type of prospective creditor 660 and the frequency of fraud attempts against that particular type of prospective creditor 660 (i.e. electronics closeout store versus medical rehabilitation equipment provider, and (3) the location of the prospective creditor 660 and the frequency of fraud attempts against prospective creditors in that location. For example, a prospective debtor 210 seeking to purchase a wheelchair from a medical supply store that has not had a specific history of fraud attempts and is located in a geographic area where fraud attempts are not common would yield a high raw score for prospective creditor's profile input factor 680. In cases where one or more of the positive factors identified in the example are not present, the raw score for prospective creditor's profile input factor 680 would be correspondingly lower.

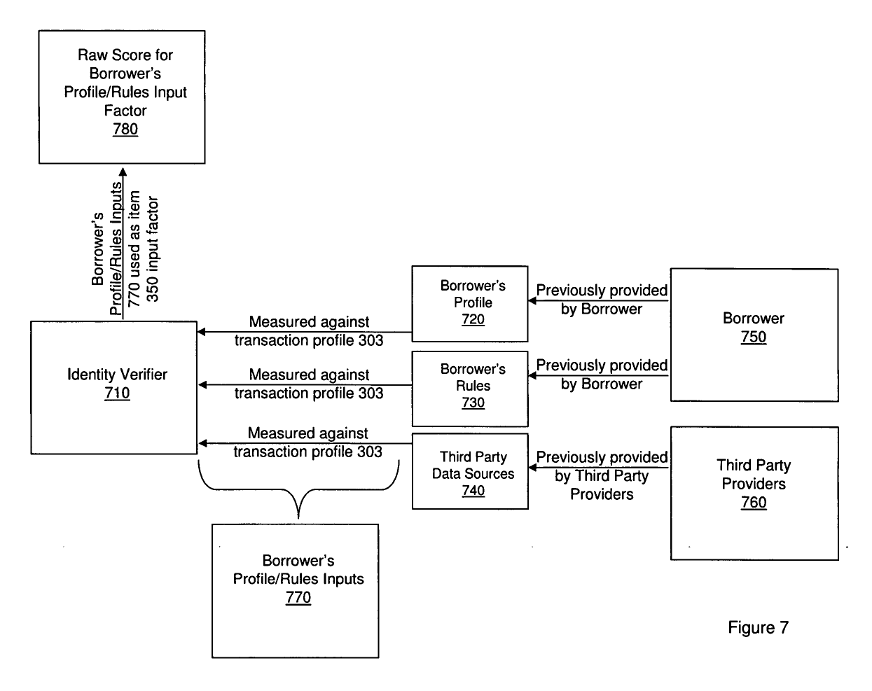

FIG. 7 a process for calculating the raw score for prospective debtor's profile/rules input factor 780 based on the prospective debtor's profile/Rules inputs 770. The prospective debtor's profile/Rules inputs 770 may include, among other things, (1) the prospective debtor's profile 720 created by prospective debtor 750 at the time prospective debtor 750 subscribed to identity verifier's 710 service, or later amended by prospective debtor 750 (2) the prospective debtor's Rules 730 provided by prospective debtor 750 at the time prospective debtor 750 subscribed to identity verifier's 710 service, or later amended by prospective debtor 750, and (3) Third Party Data Sources 740 secured by identity verifier 710. For example, a prospective debtor 750 may seek to purchase an item previously identified in prospective debtor's profile 720 as an item prospective debtor 750 plans to buy during the relevant timeframe. In the example, the purchase in question is not valued in excess of an amount set by the prospective debtor's Rule 730 to be presumed fraudulent, and third party data sources do not reveal any recent instances of identity fraud committed against the prospective debtor 750. This example would yield a high raw score for prospective debtor's profile/Rules input factor 780. In cases where one or more of the positive factors identified in the example are not present, the raw score for prospective debtor's profile/Rules input factor 780 would be correspondingly lower.

While the present invention has been disclosed with reference to certain embodiments, numerous modifications, alterations, and changes to the described embodiments are possible without departing from the sphere and scope of the present invention, as defined in the appended claims. Accordingly, it is intended that the present invention not be limited to the described embodiments, but that it has the full scope defined by the language of the following claims, and equivalents thereof.

I claim:

1. A method for performing a credit transaction, comprising: at a credit bureau, providing background information to a prospective creditor regarding a prospective debtor's credit risk; providing certain additional information to make the information more resistant to misuse by fraudulent parties who stand in the shoes of prospective debtors.
